(19) United States
(12) Patent Application Publication
(10) Pub. No.: US 2014/0370355 A1
(43) Pub. Date: Dec. 18, 2014

(54) BATTERY PACK

(71) Applicant: Samsung SDI Co., Ltd., Yongin-City (KR)

(72) Inventors: Bohyun Byun, Yongin-City (KR); Sungpyo Hong, Yongin-City (KR); Seokbong Lee, Yongin-City (KR)

(73) Assignee: Samsung SDI Co., Ltd., Yongin-City (KR)

(21) Appl. No.: 14/015,575

(22) Filed: Aug. 30, 2013

Related U.S. Application Data
(60) Provisional application No. 61/835,387, filed on Jun. 14, 2013.

(51) Int. Cl. H01M 2/22

(52) U.S. Cl. CPC H01M 2/22; H01M 2220/30
USPC 429/121

(57) ABSTRACT

An embodiment of the present invention provides a battery pack. In the proposed battery pack, when a stiffener adhered to a flexible printed circuit board protruding to the outside of an upper cover is inserted into a stiffener groove of the upper cover and fixed, a bent position of the flexible printed circuit board is set, thereby preventing the bent position of the flexible printed circuit board from being changed and fixing the flexible printed circuit board without vibration.

### BACKGROUND

1. Field

Embodiments relate to a battery pack.

2. Description of the Related Technology

Recently, compact and light portable electronic/electric apparatuses such as cellular phones, laptop computers, and camcorders have been developed and produced. Battery packs are built in the portable electronic/electric apparatuses so that the portable electronic/electric apparatuses may operate in places where power sources are not provided.

Generally, the battery pack of a portable electronic/electric apparatus includes a protective circuit for controlling the flow of electricity of a battery due to over-heating, over-current, overcharge, over-discharge, and deterioration in life time of the battery. As the functionality for improving stability of a battery pack increases, the protective circuit of the battery pack may occupy an increased mounting area. In addition, as the capacity of the battery pack increases, the current flowing through an electric device is increased, so that an area of a connector tends to also increase.

Therefore, in order to efficiently utilize the internal space of the battery pack, the protective circuit may be used in a manner that it is separated into a board having the connector connected thereto and a board having the protective circuit connected thereto. The separated boards may be connected to each other through an electric wire. In addition, in order to increase the space efficiency, a flexible board that can be bendable may be used as the board having the connector connected thereto.

### SUMMARY OF CERTAIN INVENTIVE ASPECTS

In accordance with an embodiment of the present invention, there is provided a battery pack including a bare cell having an electrode terminal provided at its upper portion, an upper cover coupled to the upper portion of the bare cell, a flexible printed circuit board having one side electrically connected to the bare cell inside the upper cover and the other side protruding to the outside of the upper cover and including a connector, and a stiffener adhered between the one and the other sides of the flexible printed circuit board, wherein the stiffener may be fixed to the outside of the upper cover.

The upper cover may include a cover plate shaped to correspond to a shape of a top surface of the bare cell and a sidewall extending from a corner of the cover plate toward the bare cell.

The stiffener is bent in an “L” shape to make close contact with an outer surface of the cover plate and an outer surface of the sidewall.

A label adhered to surround the sidewall of the upper cover may further be provided, and the label may fix the stiffener making close contact with the sidewall of the upper cover.

The upper cover may have a stiffener groove stepped on its outer surface to allow the stiffener to be inserted and fixed therein.

A fixing protrusion protruding to the outside of the upper cover may further be provided in the upper cover.

The stiffener may have a fixing hole located to correspond to the fixing protrusion to accommodate the fixing protrusion.

The upper cover may have a cover hole to allow the other side of the flexible printed circuit board to protrude to the outside.

The cover plate may further include a cover welding hole for exposing an electrode terminal of the bare cell to the outside, and water sensitive paper attached to the outer surface of the cover plate to cover the cover welding hole.

The battery pack may further include a circuit module interposed between a top portion of the bare cell and the upper cover and connected to the electrode terminal of the bare cell.

The circuit module may be located to correspond to the same line of the cover welding hole and the electrode terminal and may further include a board welding hole exposing the electrode terminal to the outside.

The flexible printed circuit board may include one side terminal connection part connected to a terminal part of the circuit module, the other side connector part having the connector and protruding to the outside of the upper cover, and a connector unit connecting the terminal connection part and the connector part, protruding to the outside of the upper cover and having the stiffener adhered thereto.

The terminal connection part may be interposed between the upper cover and the circuit module.

The battery pack may further include a plate-shaped stiffener adhered to an opposite surface of a surface of the connector part to fix the connector part.

In the battery pack according to the present invention, when a stiffener adhered to a flexible printed circuit board protruding to the outside of an upper cover is inserted into a stiffener groove of the upper cover and fixed, a bent position of the flexible printed circuit board is set, thereby preventing the bent position of the flexible printed circuit board from being changed and fixing the flexible printed circuit board without vibration.

In another aspect, the invention comprises a battery pack comprising a bare cell having a first surface and an electrode terminal formed on the first surface and a cover positioned on the bare cell so as to cover the first surface of the bare cell. In this aspect, the invention also includes a flexible printed circuit board that is electrically connected to the bare cell inside the cover wherein at least one portion of the flexible printed circuit board extends outside of the cover; and a stiffener that contacts the flexible printed circuit board outside of the cover and the cover.

In this aspect the invention can also include a protection circuit module that is positioned within the cover wherein the protection circuit module is electrically coupled to the electrode terminal of the bare cell and wherein the flexible printed circuit board is electrically connected to the electrode terminal via the protection circuit module.

### BRIEF DESCRIPTION OF THE DRAWINGS

FIG. 1 is a perspective view of a battery pack according to an embodiment of the present invention;

FIG. 2 is an exploded perspective view of the battery pack shown in FIG. 1;

FIG. 3 is a partially enlarged perspective view illustrating at another side a label has yet to be adhered in the battery pack shown in FIG. 1;

FIG. 4 is a cross-sectional view taken along the line 4-4 of the battery pack shown in FIG. 1;

FIG. 5 is a cross-sectional view taken along the line 5-5 of the battery pack shown in FIG. 1;

FIG. 6 is an enlarged perspective view illustrating a circuit module, a flexible printed circuit board and a stiffener in the battery pack shown in FIG. 1;

FIG. 7 is a partially enlarged perspective view illustrating a label has yet to be adhered in the battery pack shown in FIG. 1;

FIG. 8 is a perspective view of a battery pack according to another embodiment of the present invention;

FIG. 9 is an exploded perspective view of the battery pack shown in FIG. 8;

FIG. 10 is a perspective view illustrating the battery pack of FIG. 9 in an assembled state.

FIG. 11 is a perspective view illustrating the battery pack of FIG. 9 in a partially assembled state.

### DETAILED DESCRIPTION OF CERTAIN INVENTIVE EMBODIMENTS

Example embodiments of the present invention will now be described in more detail with reference to accompanying drawings, such that those skilled in the art can easily practice the present invention.

Here, like reference numerals refer to like elements throughout. In addition, it will be understood that when a layer or element is referred to as being “electrically connected to” another part, it can be directly on the other part, or intervening element may also be present.

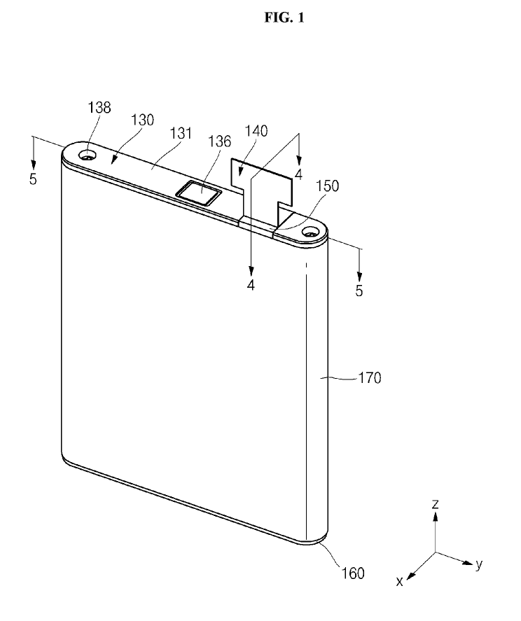

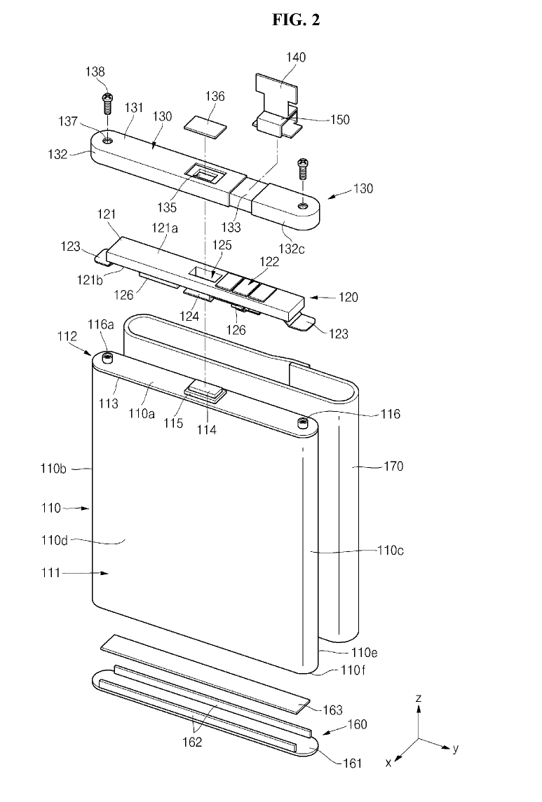

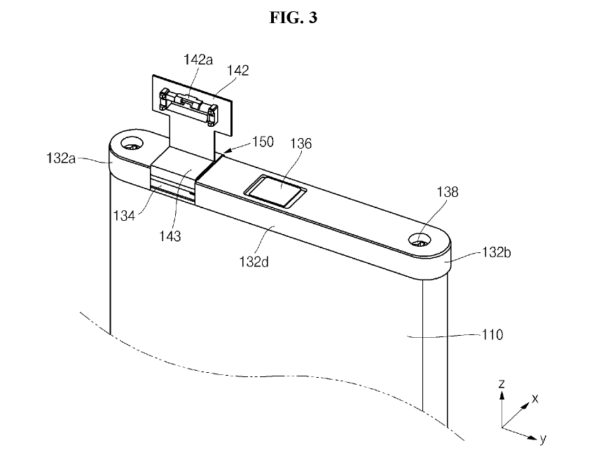

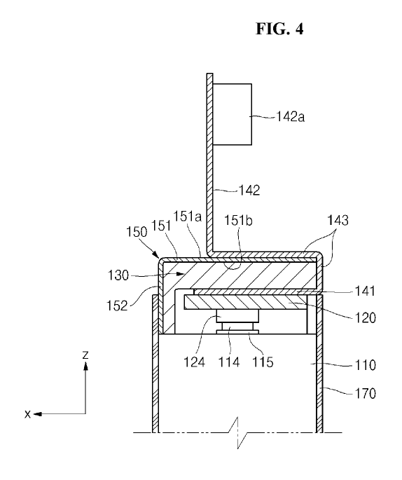

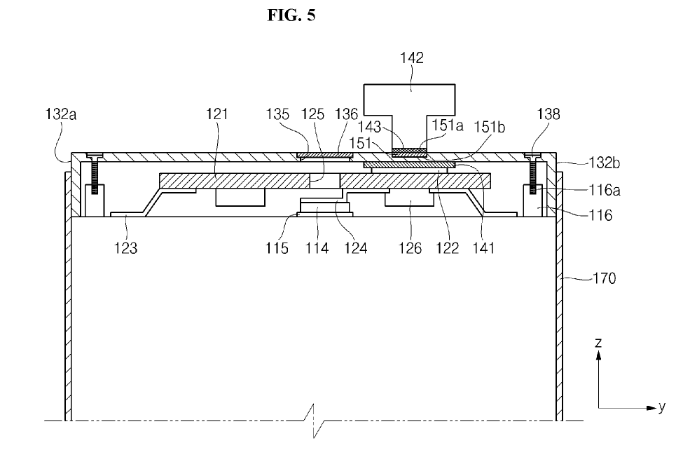

FIG. 1 is a perspective view of a battery pack according to an embodiment of the present invention, FIG. 2 is an exploded perspective view of the battery pack shown in FIG. 1, FIG. 3 is a partially enlarged perspective view illustrating a label has yet to be adhered in the battery pack shown in FIG. 1, FIG. 4 is a cross-sectional view taken along the line 4-4 of the battery pack shown in FIG. 1, and FIG. 5 is a cross-sectional view taken along the line 5-5 of the battery pack shown in FIG. 1.

Hereinafter, a battery pack according to an embodiment of the present invention will be described with reference to FIGS. 1 to 5.

As shown in FIGS. 1 to 5, the battery pack 100 includes a bare cell 110, a circuit module 120, an upper cover 130, a flexible printed circuit board (FPCB) 140, a stiffener 150, a lower cover 160 and a label 170.

The bare cell 110 may include an electrode assembly (not shown) having a positive electrode, a negative electrode and a separator interposed between the positive electrode and the negative electrode to supply electrical energy. In addition, the bare cell 110 may also include a container-type case 111 receiving the electrode assembly and an electrolytic solution (not shown), and a cap assembly 112 sealing an opening of the case 111. Here, the cap assembly 112 may include a cap plate 113 made of a metallic material, an electrode terminal 114 provided in the cap plate 113 as a protrusion, and a gasket 115 interposed between the cap plate 113 and the electrode terminal 114 and insulating the electrode terminal 114 from the cap plate 113. A cover fixing unit 116 that upwardly protrudes is provided at opposite ends of the cap plate 113 in a lengthwise direction (y). A groove 116a having a screw thread is provided inside the cover fixing unit 116. The groove 116a of the cover fixing unit 116 may be engaged with a cover screw 138 having passed through a throughhole 137 of the upper cover 130 in a threaded manner.

The case 111 and the cap plate 113 may function as a positive electrode terminal or a negative electrode terminal. In the following description, the embodiment of the present invention will be described with regard to a case where the case 111 and the cap plate 113 function as a positive electrode terminal. Accordingly, the electrode terminal 114 may function as a negative electrode terminal. Here, the case 111, the cap plate 113 and the electrode terminal 114 may have different polarities.

The bare cell 110 may include a top surface 110a corresponding to the cap plate 113 from which the electrode terminal 114 protrudes, a pair of short side surfaces 110b and 110c and a pair of long side surfaces 110d and 110e connected to the top surface 110a, and a bottom surface 110f connected to the side surfaces 110b, 110c, 110d and 110e and facing the top surface 110a. Here, the pair of short side surfaces 110b and 110c are narrow side surfaces among the side surfaces 110b, 110c, 110d and 110e connected to the top surface 110a of the bare cell 110, and the pair of long side surfaces 110d and 110e are wide side surfaces among the side surfaces 110b, 110c, 110d and 110e connected to the top surface 110a of the bare cell 110.

The circuit module 120 is disposed on the bare cell 110 and is electrically connected to the bare cell 110. The circuit module 120 may include a rigid circuit board 121, a terminal part 122, a first lead plate 123, a second lead plate 124, a board welding hole 125 and a circuit device 126.

The rigid circuit board 121 is formed of a plate made of a resin and has a top surface 121a and a bottom surface 121b. In the present disclosure, assumptions are made that the top surface 121a of the rigid circuit board 121 is the same as a top surface of the circuit module 120 and the bottom surface 121b of the rigid circuit board 121 is the same as a bottom surface of the circuit module 120.

The terminal part 122 is installed on the top surface 121a of the rigid circuit board 121 and is electrically connected to the FPCB 140. The terminal part 122 may be electrically connected to an external electronic device (not shown) through the FPCB 140.

The first lead plate 123 may be provided in pairs. At least one of the pair of first lead plates 123 is coupled to an end of the circuit module 120 to be electrically connected to a positive electrode wire pattern of the circuit module 120. The first lead plate 123 may extend toward the top surface 110a of the bare cell 110 and is connected to the top surface 110a of the bare cell 110 by resistance welding. That is to say, at least one of the pair of first lead plates 123 electrically connects the bare cell 110 and the circuit module 120. The first lead plate 123 electrically connecting the bare cell 110 and the circuit module 120 in the above-described manner may be made of a metallic material, for example, nickel or a nickel alloy. The first lead plate 123 made of an alloy may function as a positive electrode, like the top surface 110a of the bare cell 110 (that is, the cap plate 113). Of the pair of first lead plates 123, if there is a lead plate that is not made of an alloy, the lead plate may be made of an insulating material. The first lead plate 123 that is not made of an alloy may be a dummy lead plate positioned between an opposite end of the end of the circuit module 120 connected to the first lead plate 123 made of an alloy and the top surface of the bare cell 110, the dummy lead plate fixing the circuit module 120 to the top portion of the bare cell 110 to be parallel thereto.

The second lead plate 124 is installed on the bottom surface 121b of the rigid circuit board 121 to be electrically connected to a negative electrode wire pattern (not shown) of the circuit module 120. The second lead plate 124 may be electrically connected to the electrode terminal 114 by resistance welding through the board welding hole 125 and a cover welding hole 135. The second lead plate 124 may be made of a metallic material, for example, nickel or a nickel alloy. The second lead plate 124 may function as a negative electrode, like the electrode terminal 114.

The board welding hole 125 is formed to pass through the top surface 121a and the bottom surface 121b of the rigid circuit board 121. The board welding hole 125 is located at a region corresponding to the electrode terminal 114 of the bare cell 110 to provide a space in which the second lead plate 124 is welded to the electrode terminal 114 of the bare cell 110.

The circuit device 126 is formed on the bottom surface 121b of the rigid circuit board 121 and includes a charging/discharging circuit and a protective circuit. The circuit device 126 is connected between the positive and negative electrode wire patterns of the circuit module 120 to perform charging/discharging operations of the bare cell 110 and to prevent the bare cell 110 from being over-charged or over-discharged.

The upper cover 130 is coupled to the top portion of the bare cell 110 and receives the circuit module 120 in its inner space. The upper cover 130 may include a cover plate 131 and a sidewall 132 extending from a corner of the cover plate 131 toward the bare cell 110. The sidewall 132 has a uniform height (in the Z-axis direction).

The cover plate 131 may be formed to have substantially the same configuration as the top surface 110a of the bare cell 110. The inner surface of the cover plate 131 abuts to the top surface 121b of the rigid circuit board 121 in contact with the top surface 121b of the rigid circuit board 121. The cover plate 131 may include the cover welding hole 135 formed at a region corresponding to the board welding hole 125 of the circuit module 120 so as to pass through a region between the inner and outer surfaces of the cover plate 131. The cover welding hole 135 is used in welding the second lead plate 124 of the circuit module 120 to the electrode terminal 114 of the bare cell 110. The cover plate 131 may further include water sensitive paper 136 adhered to the outer surface of the cover plate 131 so as to cover the cover welding hole 135. That is to say, the water sensitive paper 136 covers the cover welding hole 135, thereby preventing foreign materials from penetrating into upper cover 130 through the cover welding hole 135. The water sensitive paper 136 may be a label having ink blurring thereon or undergoing a change in color when it is exposed to moisture. The water sensitive paper 136 may be adhered to check whether the battery pack 100 is exposed to moisture or not.

The cover plate 131 includes the throughhole 137 formed at a region corresponding to the cover fixing unit 116 at opposite ends in a lengthwise direction (y), the throughhole 137 passing through the inner and outer surfaces of the cover plate 131. A screw thread is provided in the throughhole 137 and is engaged with the cover thread 138 in a threaded manner. The lengthwise opposite ends of the cover plate 131 are coupled to the cover fixing unit 116 of the bare cell 110 by the cover thread 138. That is to say, the cover screw 138 passing through the throughhole 137 is threaded with the cover fixing unit 116, thereby coupling and fixing the upper cover 130 to the top surface of the bare cell 110.

The sidewall 132 includes opposite ends 132a and 132b positioned at lengthwise ends of the upper cover 130 and connector units 132c and 132d connecting the opposite ends 132a and 132b. The opposite ends 132a and 132b may support the cover plate 131 while making contact with regions of the top surface 110a of the bare cell 110, the regions corresponding to the short side surfaces 110b and 110c. The connector units 132c and 132d may support the cover plate 131 while making contact with regions of the top surface 110a of the bare cell 110, the regions corresponding to the long side surfaces 110d and 110e. In the following description, the connector units 132c and 132d include a front surface 132c (a positive x-axis direction) and a rear surface 132d (a negative x-axis direction). The sidewall 132 may be wrapped with the bare cell 110 by the label 170 to be described later to then be fixed to the bare cell 110.

A stiffener groove 133 may be provided on an outer surface 130a of the upper cover 130 to allow the stiffener 150 adhered to the FPCB 140 to be inserted and fixed. The stiffener groove 133 is provided on the outer surface 130a of the upper cover 130, corresponding to the terminal part 122 of the circuit module 120. The stiffener groove 133 is formed to be integrally connected to the front surface 132c of the upper cover 130, the cover plate 131 and the rear surface 132d of the upper cover 130, so that the front surface 132c of the upper cover 130, the cover plate 131 and the rear surface 132d of the upper cover 130 are stepped with respect to each other. The stiffener groove 133 has the same width (i.e., a width in the y-axis direction) as a width of the stiffener 150 (the width in the y-axis direction). In addition, a depth of the stiffener groove 133 is equal to a thickness of the stiffener 150.

In addition, a cover hole 134 passing through the outer and inner surfaces of the upper cover 130 is further provided in the stiffener groove 133 in the rear surface 132d of the upper cover 130. A width of the cover hole 134 (in the y-axis direction) may be equal to that of the stiffener groove 133. The cover hole 134 is a hole for allowing the FPCB 140 connected to the terminal part 122 of the circuit module 120 to protrude to the outside. That is to say, the FPCB 140 protrudes to the outside through the cover hole 134.

The FPCB 140 includes a connector 142a, and one side of the FPCB 140 is electrically connected to the terminal part 122 of the circuit module 120 inside the upper cover 130 and the other side thereof protrudes to the outside of the upper cover 130. The FPCB 140 has a ductile metal circuit pattern formed on a film as a base layer, the film made of polyimide or polyethylene terephtlate (PET). The FPCB 140 having the ductile metal circuit pattern formed on the film-type base layer may be bent well. In addition, one and the other sides of the FPCB 140 are electrically connected to each other by a circuit pattern.

The FPCB 140 includes a terminal connection part 141 having one side connected to the terminal part 122 of the circuit module 120 and a connector part 142 having a connector 142a provided at the other side. The FPCB 140 may further include a connector unit 143 connecting the terminal connection part 141 and the connector part 142 to each other. The FPCB 140 is shaped of a plate and is easily bendable. A surface of the terminal connection part 141 connected to the terminal part 122 of the circuit module 120 and a surface of the connector part 142 having the connector 142a may be coplanar.

The terminal connection part 141, shaped of a planar plate, is welded to the terminal part 122 of the circuit module 120 to then be electrically connected to the circuit module 120. The terminal connection part 141 may be shaped to correspond to the terminal part 122 of the circuit module 120. The terminal connection part 141, interposed between the circuit module 120 and the cover plate 131, is positioned inside the upper cover 130.

The connector part 142 includes the connector 142a electrically connected to an external electronic device or a charger. The connector 142a is electrically connected to the terminal part 122 of the circuit module 120 through the circuit pattern of the FPCB 140. The connector part 142 upwardly protrudes to be perpendicular to the cover plate 131 of the upper cover 130. Here, the connector 142a is positioned at the connector part 142 in a direction of the rear surface 132d of the upper cover 130 (that is, a negative x-axis direction).

The connector unit 143 connects the terminal connection part 141 to the connector part 142. The connector unit 143 outwardly protrudes through the cover hole 134 of the upper cover 130 and is bent along the stiffener groove 133 of the upper cover 130. When the stiffener 150 adhered to the FPCB 140 is inserted into the stiffener groove 133 of the upper cover 130, the connector unit 143 is bent along the stiffener groove 133 of the cover plate 131.

That is to say, if the stiffener 150 is inserted into the stiffener groove 133 of the upper cover 130, the connector unit 143 is upwardly bent at an end of a terminal connection part 141a to make close contact with the rear surface 132d of the upper cover 130, and a portion of the connector unit 143 adhered to the stiffener 150 is bent in a horizontal direction (i.e., a positive x-axis direction) corresponding to the outer surface of the cover plate 131. The connector unit 143 is connected to the end of the connector 142 in an upwardly perpendicular direction from the cover plate 131.

In the FPCB 140, the connector unit 143 is configured such that a surface of the connector unit 143 opposite to a surface having the terminal connection part 141 and the connector part 142 is adhered to the stiffener 150. The connector unit 143 is bent along the cover plate 131 so as to make close contact with the upper cover 130 when the stiffener 150 is fixedly inserted into the stiffener groove 133 of the upper cover 130.

As shown in FIG. 6, if the stiffener 150 is inserted into the stiffener groove 133 after the FPCB 14 adhered to the stiffener 150 is connected to the terminal part 122 of the circuit module 120, the stiffener 150 is bent along the stiffener groove 133 of the upper cover 130, as shown in FIG. 3. That is to say, the stiffener 150 is inserted into the stiffener groove 133 of the upper cover 130 to then be fixed, thereby setting the bent position of the FPCB 140, thereby preventing a bending failure from occurring and preventing the FPCB 140 from vibrating.

The stiffener 150 is adhered to the FPCB 140. The stiffener 150 is adhered to a surface of the connector unit 14 of the FPCB 140, opposite to a surface of the connector unit 14 having the terminal connection part 141 and the connector part 142. The stiffener 150 is inserted into the stiffener groove 133 formed on the outer surface 130a of the upper cover 130, thereby fixing the FPCB 140 to the upper cover 130. The stiffener 150 may be made of a rigid metallic material or an insulating material.

The stiffener 150 is shaped to correspond to the stiffener groove 133 formed on the cover plate 131 of the upper cover 130 and the front surface 132c of the upper cover 130. The stiffener 150 is bent in an “L” shape, having a first plate 151 formed in a horizontal direction (i.e., in the x-axis direction) and a second plate 152 formed in a vertical direction (i.e., in the z-axis direction). The first plate 151 has an outer surface 151a adhered to the connector unit 142 of the FPCB 140, and an inner surface 151b inserted into the stiffener groove 133 of the cover plate 131 to make close contact with the stiffener groove 133. That is to say, the first plate 151 is disposed between the cover plate 131 and the connector unit 14 of the FPCB 140 parallel to the cover plate 131. The second plate 152 has an inner surface 152b inserted into the stiffener groove 133 formed in the front surface 132c of the upper cover 130 to make close contact with the stiffener groove 133 of the upper cover 130. In addition, the second plate 152 is inserted into the stiffener groove 133, so that the outer surface 152a is coplanar with the outer surface 130a of the upper cover 130. That is to say, since a thickness of the stiffener 150 is equal to a depth of the stiffener groove 133, the outer surface 152a of the stiffener 150 becomes coplanar with the outer surface 130a of the upper cover 130. The stiffener 150 may be wrapped with the sidewall 132 of the upper cover 130 by the label 170 to be described later to then be fixed to the upper cover 130.

As described above, since the stiffener 150 is inserted into the stiffener groove 133 to then be fixed, the bent position of the adhered FPCB 140 can be set, thereby preventing the bent position from being changed while fixing the FPCB 140.

The lower cover 160 is coupled to a bottom surface 110f of the bare cell 110 from a lower portion of the bare cell 110. The lower cover 160 may include a plate 161 making contact with the bottom surface 110f of the bare cell 110 and a cell support unit 162 upwardly protruding to face the bare cell 110 from the plate 161. The lower cover 160 may be attached to the bottom surface 110f of the bare cell 110 by an adhesion member 163.

The plate 161 has substantially the same shape as the bottom surface 110f of the bare cell 110, and may be coupled to make contact with the bottom surface 110f of the bare cell 110 and may be attached to the bottom surface 110f of the bare cell 110 by the adhesion member 163.

The cell support unit 162 may be provided in pair at edges of the plate 161 along long sides of the plate 161. The pair of cell support units 162 is coupled while covering lower portions of the long sides 110d and 110e of the bare cell 110. The cell support unit 162 may be wrapped by the label 170 to be described later to then be maintained at a state in which it is coupled to the bare cell 110. However, when the adhesion member 163 is provided to adhere the plate 161 to the bottom surface 110f of the bare cell 110, the cell support unit 162 may not be provided by selection by one skilled in the art.

The label 170 is adhered to wrap side surfaces 110b, 110c, 110d, and 110e of the bare cell 110. The label 160 wraps the sidewall 132 of the upper cover 130, the second plate 152 of the stiffener 150 and the cell support unit 162 of the lower cover 160. The label 170 is provided to reinforce coupling forces between each of the upper cover 130, the stiffener 150 and the lower cover 160 the FPCB 140.

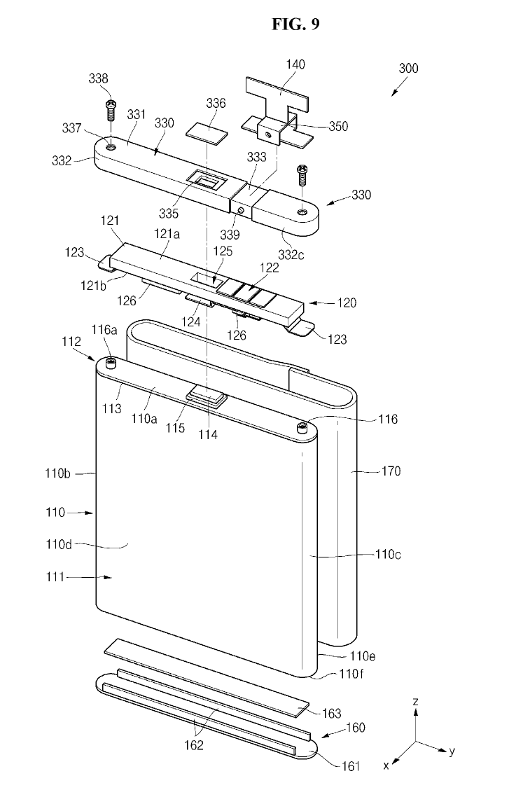

FIG. 8 is a perspective view of a battery pack according to another embodiment of the present invention.

Referring to FIG. 8, the battery pack 200 includes a bare cell 110, a circuit module 120, an upper cover 130, an FPCB 140, a stiffener 150, a lower cover 160, a label 170 and an auxiliary stiffener 280.

The battery pack 200 shown in FIG. 8 is substantially the same as the battery pack 100 shown in FIG. 1, in terms of configurations of the bare cell 110, the circuit module 120, the upper cover 130, the FPCB 140, the stiffener 150, the lower cover 160 and the label 170. Thus, the following description of the battery pack 200 will focus on the auxiliary stiffener 280, which is not provided in the battery pack 100 shown in FIG. 1.

The auxiliary stiffener 280, which is substantially plate-shaped, is adhered to the FPCB 140. The auxiliary stiffener 280 is adhered to the FPCB 140 to cover a surface of the connector part 142, opposite to a surface having the connector 142a. The connector 142a is positioned on the connector part 142 of the FPCB 140 in a direction of the rear surface 132d of the upper cover 130 upwardly protruding from the cover plate 131 of the upper cover 130 (i.e., in a negative x-axis direction). That is to say, the auxiliary stiffener 280 is positioned on the part 142 of the FPCB 140 in a direction of the front surface 132c of the upper cover 130 upwardly protruding from the cover plate 131 of the upper cover 130 (i.e., in a positive x-axis direction).

One end 280a of the auxiliary stiffener 280 is connected to the outer surface 151a of the first plate 151 of the stiffener 150 and the other end 280b of the auxiliary stiffener 280 may be coplanar with the end of the connector part 142 of the FPCB 140. The auxiliary stiffener 280 may be made of a rigid metallic material or an insulating material.

The auxiliary stiffener 280 may prevent the connector part 142 of the FPCB 140 from being bent and may support the FPCB 140 to be kept at a state in which the connector part 142 of the FPCB 140 is vertically disposed.

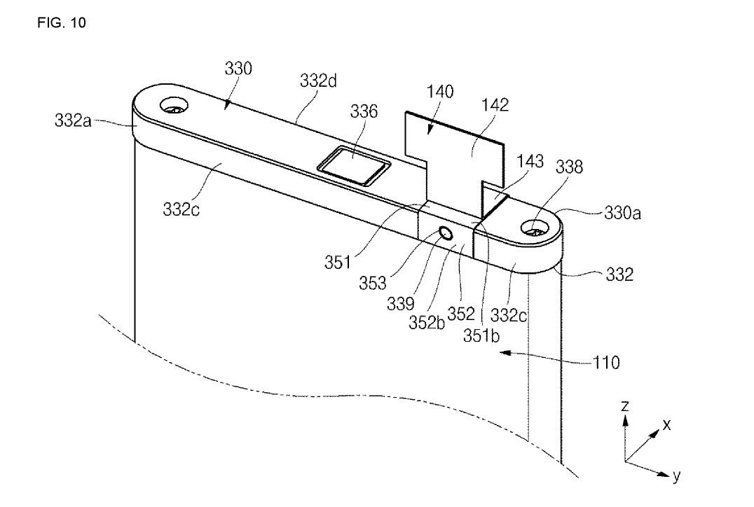

FIG. 9 is an exploded perspective view of the battery pack shown in FIG. 8 and FIG. 10 is a partially enlarged perspective view illustrating a label has yet to be adhered in the battery pack shown in FIG. 9.

As shown in FIGS. 9 and 10, the battery pack 300 includes a bare cell 110, a circuit module 120, an upper cover 330, an FPCB 140, a stiffener 350, a lower cover 160 and a label 170.

The battery pack 300 shown in FIGS. 9-11 is substantially the same as the battery pack 100 shown in FIG. 1, in terms of configurations of the bare cell 110, the circuit module 120, the FPCB 140, the lower cover 160 and the label 170. Thus, the following description of the battery pack 200 will focus on the upper cover 330 and the stiffener 350, which are different components from the battery pack 100 shown in FIG. 1.

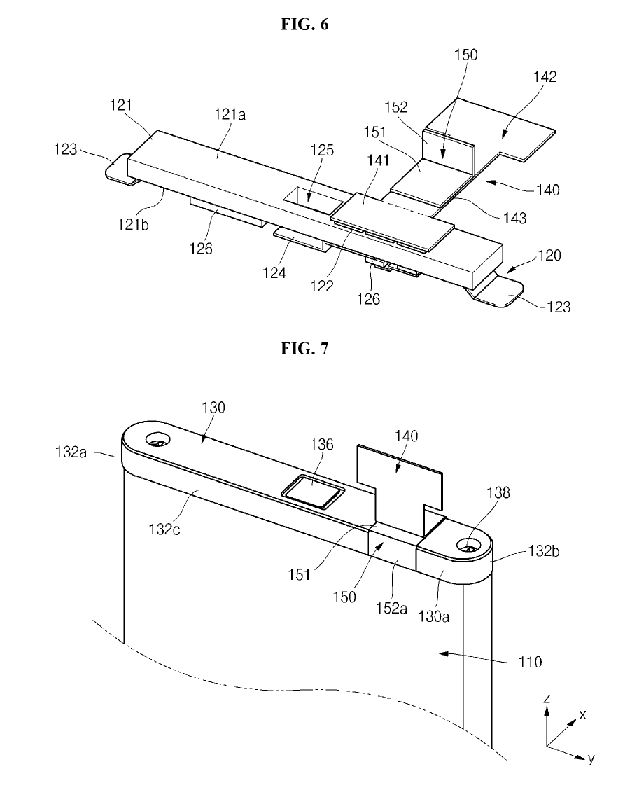

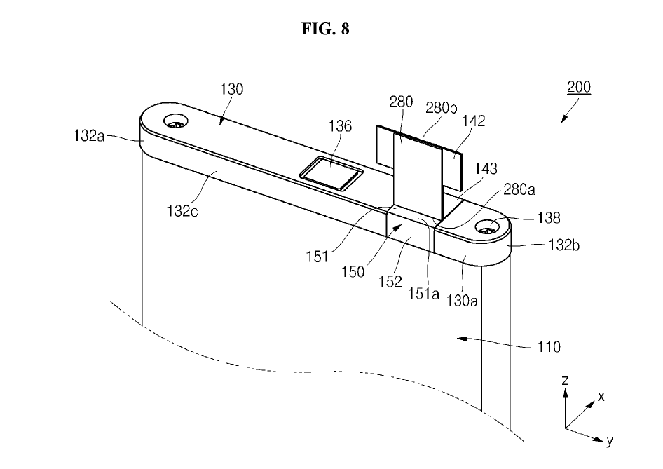

The upper cover 330 is coupled to a top portion of the bare cell 110 and accommodates the circuit module 120 in its inner space. The upper cover 330 may include a cover plate 331 and a sidewall 332 extending from a corner of the cover plate 331 toward the circuit module 120. The sidewall 332 may have a uniform height (in the Z-axis direction). The upper cover 330 is substantially the same as that of the battery pack 100 shown in FIGS. 1 to 7, except for the stiffener groove 333, and the following description will focus on the stiffener groove 333.

The stiffener groove 333 may be provided on an outer surface 330a of the upper cover 330 to allow the stiffener 350 adhered to the FPCB 140 to be inserted and fixed. The stiffener groove 333 is provided on the outer surface 330a of the upper cover 330, corresponding to a terminal part 122 of the circuit module 120. The stiffener groove 333 is formed to be integrally connected to a front surface 332c of the upper cover 330, the cover plate 331 and a rear surface 332d of the upper cover 330, so that the front surface 332c of the upper cover 330, the cover plate 331 and the rear surface 332d of the upper cover 330 are stepped with respect to each other. The stiffener groove 333 has the same width (i.e., a width in the y-axis direction) as a width of the stiffener 350 (the width in the y-axis direction). In addition, a depth of the stiffener groove 333 is equal to a thickness of the stiffener 350.

In addition, a fixing protrusion 339 that outwardly protrudes is further provided in the stiffener groove 333 of the front surface 332c of the upper cover 330. A height of the fixing protrusion 339 may be equal to a depth of the stiffener groove 333 and a thickness of the stiffener 350. The fixing protrusion 339 may be engaged with the fixing hole 353 of the stiffener 150 inserted into the stiffener groove 333. The fixing protrusion 339 may have any shape as long as it is shaped to protrude from the front surface 332c of the upper cover 330. In addition, in the illustrated embodiment, the fixing protrusion 339 is cylindrical, but the invention does not limit the shape of the fixing protrusion 339 to that illustrated herein. In addition, in the illustrated embodiment, the fixing protrusion 339 is formed at the center of the stiffener groove 333 of the front surface 332c of the upper cover 330, but not limited thereto. That is to say, the fixing protrusion 339 may be formed at any region as long as it corresponds to the fixing hole 353 of the stiffener 350, but aspects of the present invention are not limited thereto.

In addition, a cover hole 334 passing through outer and inner surfaces of the upper cover 330 is further provided in the stiffener groove 333 in the rear surface 332d of the upper cover 330. A width of the cover hole 334 (in the y-axis direction) may be equal to that of the stiffener groove 333. The cover hole 334 is a hole for allowing the FPCB 140 connected to the terminal part 122 of the circuit module 120 to protrude to the outside in the same manner as described above. That is to say, the FPCB 140 protrudes to the outside through the cover hole 334.

The stiffener 350 adhered to the FPCB 140. The stiffener 350 is adhered to a surface of the connector unit 14 of the FPCB 140, opposite to a surface of the connector unit 14 having the terminal connection part 141 and the connector part 142. The stiffener 350 is inserted into the stiffener groove 333 formed on the outer surface 330a of the upper cover 330, thereby fixing the FPCB 140 to the upper cover 330. The stiffener 350 may be made of a rigid metallic material or an insulating material.

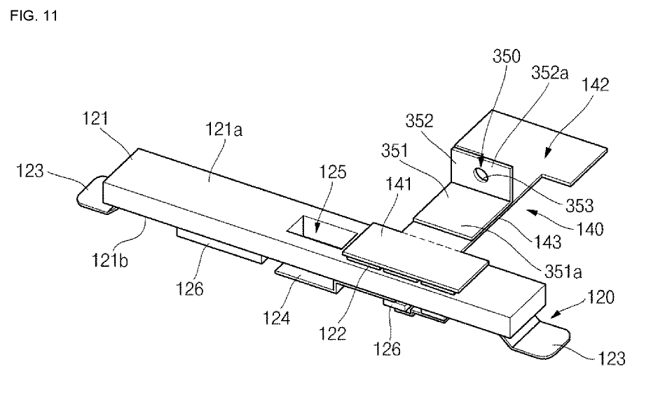

The stiffener 350 is shaped to correspond to the stiffener groove 333 formed on the cover plate 331 of the upper cover 330 and the front surface 332c of the upper cover 330. The stiffener 350 is bent in an “L” shape, having a first plate 351 formed in a horizontal direction (i.e., in the x-axis direction) and a second plate 352 formed in a vertical direction (i.e., in the z-axis direction) as shown in FIG. 10. As shown in FIG. 11, the stiffener 350 is initially flat with an end inserted into the opening in the cover 330. The stiffener 350 is then bent into the configuration shown in FIG. 10.

The first plate 351 has an outer surface 351a adhered to the connector unit 14 of the FPCB 140, and an inner surface 351b inserted into the stiffener groove 333 of the cover plate 331 to make close contact with the stiffener groove 333. That is to say, the first plate 351 is disposed between the cover plate 331 and the connector unit 143 of the flexible printed circuit board 140 parallel to the cover plate 331.

The second plate 352 has an inner surface 352b inserted into the stiffener groove 333 formed in the front surface 332c of the upper cover 330 to make close contact with the stiffener groove 333 of the upper cover 330. In addition, a fixing hole 353 passing through the inner surface 352a and the inner surface 352b is provided in the second plate 352. The fixing hole 353 has the same shape as the stiffener 350 corresponding to a region where a fixing protrusion 329 provided in the stiffener groove 133. The fixing protrusion 329 provided in the stiffener groove 333 passes through the fixing hole 353 to allow the stiffener 350 to be fixedly coupled to the stiffener groove 333.

In addition, the inner surface 352b of the second plate 352 is inserted into the stiffener groove 333 formed on the front surface 332c of the upper cover 330 to make close contact with the stiffener groove 333 of the upper cover 330. In addition, the second plate 352 is inserted into the stiffener groove 333, so that the outer surface 352a of the second plate 352 may become coplanar with the outer surface 330a of the upper cover 330, and an end of the fixing protrusion 329 may also be coplanar with the outer surface 330a of the upper cover 330. That is to say, since a thickness of the stiffener 350 is equal to a depth of the stiffener groove 333, the outer surface 352a of the second plate 352 of the stiffener 350 becomes coplanar with the outer surface 330a of the upper cover 330. The stiffener 350 may be wrapped with the sidewall 332 of the upper cover 330 by the label 170 to be described later to then be fixed to the upper cover 330.

As described above, since the stiffener 350 is inserted into the stiffener groove 333 to then be fixed, the bent position of the adhered FPCB 140 can be set, thereby preventing the bent position from being changed while fixing the FPCB 140.

While the invention has been described in connection with certain exemplary embodiments, it will be understood by those skilled in the art that the invention is not limited to the disclosed embodiment, but rather is intended to cover various modifications included within the spirit and scope of the appended claims and equivalents thereof.

What is claimed is:

1. A battery pack comprising:
a bare cell having a first surface and an electrode terminal formed on the first surface;
a cover positioned on the bare cell so as to cover the first surface of the bare cell;
a flexible printed circuit board that is electrically connected to the bare cell inside the cover wherein at least one portion of the flexible printed circuit board extends outside of the cover; and
a stiffener that contacts the flexible printed circuit board outside of the cover and the cover

2. The battery pack of claim 1, further comprising a protection circuit module that is positioned within the cover wherein the protection circuit module is electrically coupled to the electrode terminal of the bare cell and wherein the flexible printed circuit board is electrically connected to the electrode terminal via the protection circuit module.

3. The battery pack of claim 1, wherein the cover defines an opening that receives a first portion of the flexible printed circuit board.

4. The battery pack of claim 3, wherein the cover has a first and a second side surfaces and an upper surface and wherein the opening is formed in the first side surface of the cover and the flexible printed circuit board includes a second portion that is positioned outside of the cover.

5. The battery pack of claim 4, wherein the second portion of the flexible printed circuit board has a first sub-portion that is positioned above the cover so as to extend substantially parallel to the upper surface of the cover and a second sub-portion that extends substantially perpendicular to the upper surface of the cover.

6. The battery pack of claim 5, wherein the second portion comprises a third sub-portion that is positioned adjacent the first side surface of the cover.

7. The battery pack of claim 5, wherein the stiffener has a first portion that is connected to the cover and a second portion that contacts the second sub-portion of the flexible printed circuit board that extend substantially perpendicular to the upper surface of the cover.

8. The battery pack of claim 5, wherein the stiffener is connected to the second side surface and the upper surface of the cover and wherein the first sub-portion of the flexible printed circuit board that is positioned above the upper surface of the cover is positioned on a portion of the stiffener positioned on the upper surface of the cover.

9. The battery pack of claim 3, wherein the cover defines a groove that is sized and positioned to receive the stiffener.

10. The battery pack of claim 9, wherein the groove has a depth that is substantially equal to the thickness of the stiffener.

11. The battery pack of claim 9, wherein the groove is further sized and positioned to receive a portion of the flexible printed circuit board that extends outward from the opening in the first side surface of the cover and is positioned adjacent the first side surface of the cover.

12. The battery pack of claim 1, further comprising a label that engages with the cover and the stiffener so as to retain the stiffener in contact with the cover.

13. The battery pack of claim 1, wherein the cover and stiffener includes a mounting protrusion and an opening that is sized and positioned to receive the mounting protrusion.

14. A battery pack comprising:
a bare cell having a first surface and an electrode terminal formed on the first surface;
a cover positioned on the bare cell so as to cover the first surface of the bare cell;
a flexible printed circuit board that has a first portion that is positioned within the cover and is electrically connected to the bare cell inside the cover wherein a second portion of the flexible printed circuit board extends outside of the cover and wherein the flexible printed circuit board is bent so as to extend in at least two directions; and
a stiffener that contacts the flexible printed circuit board and the cover wherein the stiffener contacts the flexible printed circuit board at least one location where the flexible printed circuit board is bent.

15. The battery pack of claim 14, wherein the cover has a first and a second side surfaces and an upper surface and wherein an opening is formed in the first side surface of the cover and the second portion of the flexible printed circuit board includes afirst sub-portion that is positioned above the upper surface of the cover.

16. The battery pack of claim 15, wherein the first sub-portion of flexible printed circuit board that is positioned above the cover extends substantially parallel to the upper surface of the cover and wherein the second portion of the flexible printed circuit board includes a second sub-portion that extends substantially perpendicular to the upper surface of the cover.

17. The battery pack of claim 16, wherein the second portion comprises a third sub-portion that is positioned adjacent the first side surface of the cover.

18. The battery pack of claim 16, wherein the stiffener has a first portion that is connected to the second side surface cover and a second portion that contacts the second sub-portion of the flexible printed circuit board that extend substantially perpendicular to the upper surface of the cover.

19. The battery pack of claim 14, wherein the cover defines a groove that is sized and positioned to receive the stiffener.

20. The battery pack of claim 14, wherein the cover and the stiffener includes a mounting protrusion and an opening that is sized and positioned to receive the mounting protrusion.
